(19) United States
(12) Patent Application Publication
(10) Pub. No.: US 2024/0422697 A1
(43) Pub. Date: Dec. 19, 2024

(54) METHOD AND DEVICE IN NODES USED FOR WIRELESS COMMUNICATION

(71) Applicants: Lu WU, Shanghai (CN); Xiaobo ZHANG, Shanghai (CN)

(72) Inventors: Lu WU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/822,491

(22) Filed: Sep. 3, 2024

Related U.S. Application Data
(63) Continuation of application No. PCT/CN2023/079533, filed on Mar. 3, 2023.

(30) Foreign Application Priority Data
Mar. 9, 2022 (CN) 202210221872.5

(51) Int. Cl. H04W 52/32; H04L 5/00; H04W 52/36

(52) U.S. Cl. CPC H04W 52/325; H04L 5/0051; H04W 52/367

(57) ABSTRACT

A first node receives a first signaling and transmits a first signal. The first signal is a first-type signal or a second-type signal, and the first signaling is used to indicate a first reference signal resource from the first reference signal resource set or the second reference signal resource set; a target parameter is used to determine transmit power of the first-type signal and transmit power of the second-type signal; a first candidate value group comprises one or multiple candidate values of the target parameter corresponding to the first reference signal resource; the first candidate value group comprises a target value, and the target value is used to determine transmit power of the first signal; a number of candidate value(s) comprised in the first candidate value group is related to whether a first condition is satisfied.

### CROSS REFERENCE TO RELATED APPLICATIONS

This application is the continuation of the international patent application No. PCT/CN2023/079533, filed on Mar. 3, 2023, and claims the priority benefit of Chinese Patent Application CN202210221872.5, filed on Mar. 9, 2022, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### RELATED ART

In 5G NR (New Radio) system, multiple antenna panels will be configured for both base station and terminal. NR Rel-16 standard can already support the base station to transmit radio signals through multiple antenna panels at the same time, but the terminal only supports transmission based on antenna panel selection even if it is configured with multiple antenna panels, i.e., radio transmission is only allowed to be performed on one antenna panel at the same time. In the future evolution of the 5G NR system, in order to increase the system capacity, it is necessary to support both single-panel transmission at the base station and terminal and transmit radio signals on multiple antenna panels at the same time.

### SUMMARY

Inventors have found through researches that how to determine transmit power of the signal is a key problem to be solved.

To address the above problem, the present application provides a solution. It should be noted that although the uplink and downlink are used as an example in the above description, the application is also applicable to other scenarios, such as sidelink, where similar technical effects can be achieved. Additionally, the adoption of a unified solution for various scenarios (including but not limited to Downlink, Uplink and Sidelink) contributes to the reduction of hardcore complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling; and
transmitting a first signal;
herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, a problem to be solved in the present application comprises: how to determine transmit power of the signal.

According to one aspect of the present application, it is characterized in that the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

According to one aspect of the present application, it is characterized in that when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set.

According to one aspect of the present application, it is characterized in that when and only when the first condition is not satisfied, the first signaling is used to indicate the target value from the first candidate value set.

According to one aspect of the present application, it is characterized in that the first signaling comprises a first field, and the first field in the first signaling is used to indicate the first reference signal resource from the first reference signal resource set or the second reference signal resource set; an interpretation of the first field in the first signaling is related to whether the first condition is satisfied.

According to one aspect of the present application, it is characterized in that a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

According to one aspect of the present application, comprising:
transmitting a first information block;
herein, the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

The present application provides a method in a second node for wireless communications, comprising:
transmitting a first signaling; and
receiving a first signal;
herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

According to one aspect of the present application, it is characterized in that the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

According to one aspect of the present application, it is characterized in that when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set.

According to one aspect of the present application, it is characterized in that when and only when the first condition is not satisfied, the first signaling is used to indicate the target value from the first candidate value set.

According to one aspect of the present application, it is characterized in that the first signaling comprises a first field, and the first field in the first signaling is used to indicate the first reference signal resource from the first reference signal resource set or the second reference signal resource set; an interpretation of the first field in the first signaling is related to whether the first condition is satisfied.

According to one aspect of the present application, it is characterized in that a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

According to one aspect of the present application, comprising:
receiving a first information block;
herein, the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

The present application provides a first node for wireless communications, comprising:
a first receiver, receiving a first signaling; and
a first transmitter, transmitting a first signal;
herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

The present application provides a second node for wireless communications, comprising:
a second transmitter, transmitting a first signaling; and
a second receiver, receiving a first signal;
herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the present application has the following advantages over conventional schemes:
the proposed transmit power scheme takes into account the beam direction/antenna panel/transmitting and receiving node factors, and takes into account the transmission under single and multiple beam directions/antenna panel/transmitting and receiving node.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first signaling and a first signal according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless communications according to one embodiment of the present application;

FIG. 6 illustrate a schematic diagram of relations among a first candidate value group, a target value and a first condition according to one embodiment of the present application;

FIG. 7 illustrates a schematic diagram of a determination of a target value according to one embodiment of the present application;

FIG. 8 illustrates a schematic diagram of a determination of a target value according to another embodiment of the present application;

FIG. 9 illustrates a schematic diagram of a determination of a target value according to another embodiment of the present application;

FIG. 10 illustrates a schematic diagram of a relation between a first field and a first condition according to one embodiment of the present application;

FIGS. 11A-11D illustrate schematic diagrams of a given reference power value according to one embodiment of the present application;

FIG. 12 illustrate a schematic diagram of a relation between an interpretation for a first field in a first signaling and a first condition according to one embodiment of the present application;

FIG. 13 illustrates a structure block diagram of a processor in a first node according to one embodiment of the present application;

FIG. 14 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

Embodiment 1 illustrates a flowchart of a first signaling and a first signal according to one embodiment of the present application, as shown in FIG. 1. In step 100 illustrated by FIG. 1, each box represents a step.

In Embodiment 1, the first node in the present application receives a first signaling in step 101; transmits a first signal in step 102; herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first signaling is a physical-layer signaling.

In one embodiment, the first signaling is a Downlink Control Information (DCI) signaling.

In one embodiment, the first signaling is a DCI signaling used to schedule a PUSCH (Physical Uplink Shared CHannel).

In one embodiment, the first signaling is transmitted through a Physical Downlink Control Channel (PDCCH).

In one embodiment, the first signaling indicates time-frequency resources occupied by the first signal.

In one embodiment, the first signaling indicates scheduling information of the first signal.

In one embodiment, the scheduling information of the first signal comprises occupied time-domain resources and occupied frequency-domain resources.

In one embodiment, the scheduling information of the first signal comprises at least one of occupied time-domain resources, occupied frequency-domain resources, a Modulation and Coding Scheme (MCS), configuration information of DeModulation Reference Signals (DMRS), a Hybrid Automatic Repeat reQuest (HARQ) process number, a Redundancy Version (RV), a New Data Indicator (NDI), a transmitting antenna port, a Transmission Configuration Indicator (TCI) state, a Sounding Reference Signal (SRS) resource indication or pre-coding information and layers.

In one embodiment, the first signal is transmitted on a PUSCH.

In one embodiment, the first signal carries a Transport Block (TB).

In one embodiment, the first signal carries at least one transport block.

In one embodiment, the first signal carries at least one Code Block Group (CBG).

In one embodiment, the first-type signal and the second-type signal are both transmitted on PUSCH.

In one embodiment, the first-type signal and the second-type signal belong to a same cell.

In one embodiment, the first-type signal and the second-type signal belong to a same serving cell.

In one embodiment, when the first reference signal resource belongs to the first reference signal resource set, the first signal is the first-type signal; when the first reference signal resource belongs to the second reference signal resource set, the first signal is the second-type signal.

In one embodiment, any reference signal resource in the first reference signal resource set and the second reference signal resource set is a CSI-RS (Channel State Information Reference Signal) resource, an SS/PBCH (Synchronization/Physical Broadcast Channel) block, or an SRS (Sounding Reference Signal) resource.

In one embodiment, any reference signal resource in the first reference signal resource set and the second reference signal resource set is an SRS resource.

In one embodiment, the first reference signal resource set and the second reference signal resource set are indicated by a higher-layer signaling.

In one embodiment, the first reference signal resource set and the second reference signal resource set are different.

In one embodiment, the first reference signal resource set and the second reference signal resource set are indicated by srs-ResourceSetToAddModList parameters.

In one embodiment, the first reference signal resource set is indicated by an srs-ResourceSetToAddModList parameter, and the second reference signal resource set is indicated by an srs-ResourceSetToAddModList parameter.

In one embodiment, the first reference signal resource set is indicated by IE SRS-Config, and the second reference signal resource set is indicated by IE SRS-Config.

In one embodiment, the first reference signal resource set and the second reference signal resource set are respectively indicated by two SRS-Config IEs.

In one embodiment, the first reference signal resource set and the second reference signal resource set are indicated by a same IE SRS-Config.

Typically, an antenna port group comprises one or multiple antenna ports.

In one embodiment, the meaning of the phrase that a given reference signal resource is used to determine an antenna port group for transmitting a given signal comprises: an antenna port group for transmitting the given signal is the same as an antenna port group for the given reference signal resource.

In one embodiment, the meaning of the phrase that a given reference signal resource is used to determine an antenna port group for transmitting a given signal comprises: a number of antenna port(s) comprised in an antenna port group for transmitting the given signal is the same as a number of antenna port(s) for the given reference signal resource.

In one embodiment, the meaning of the phrase that a given reference signal resource is used to determine an antenna port group for transmitting a given signal comprises: an antenna port group for transmitting the given signal and an antenna port group for the given reference signal resource have a same spatial relation.

In one embodiment, the spatial relation comprises: Spatial Tx parameters.

In one embodiment, the spatial relation comprises: spatial domain transmission filter.

In one embodiment, the spatial relation comprises: precoding.

In one embodiment, the spatial relation comprises: beamforming.

In one embodiment, the given reference signal resource is a reference signal resource in the first reference signal resource set, and the given signal is a first-type signal.

In one embodiment, the given reference signal resource is a reference signal resource in the second reference signal resource set, and the given signal is a second-type signal.

In one embodiment, the given reference signal resource is the first reference signal resource, and the given signal is the first signal.

In one embodiment, the given reference signal resource is the second reference signal resource, and the given signal is the second signal.

In one embodiment, the first signaling comprises a first field, and the first field in the first signaling is used to indicate the first reference signal resource from the first reference signal resource set or the second reference signal resource set.

In one embodiment, the first signaling is used to indicate a first reference signal resource from the first reference signal resource set, where the first reference signal resource is a reference signal resources in the first reference signal resource set; or, the first signaling is used to indicate a first reference signal resource from the second reference signal resource set, where the first reference signal resource is a reference signal resource in the second reference signal resource set.

In one embodiment, one field comprises at least one bit.

In one embodiment, the target value is a real number, and any candidate value in the first candidate value group is a real number.

In one embodiment, the target value is an integer, and any candidate value in the first candidate value group is an integer.

In one embodiment, transmit power of a given signal is a minimum value of a given power threshold and a given reference power value, and the target parameter is used to determine the given reference power value; transmit power of the first signal is a minimum value of a first power threshold and a first power value, and the target value is used to determine the first power value.

In one embodiment, transmit power of a given signal is a minimum value of a given power threshold and a given reference power value, and the target parameter is used to determine the given power threshold; transmit power of the first signal is a minimum value of a first power threshold and a first power value, and the target value is used to determine the first power threshold.

In one embodiment, the given signal is either the first-type signal or the second-type signal.

In one embodiment, transmit power of a given signal is not greater than a given power threshold and not greater than a given reference power value.

In one embodiment, transmit power of a given signal is not greater than a given power threshold, and the target parameter is used to determine the given power threshold; the transmit power of the first signal is not greater than a first power threshold, and the target value is used to determine the first power threshold.

In one embodiment, the transmit power of the first signal is not greater than the first power threshold and not greater than the first power value.

In one embodiment, the target parameter is used to determine the given power threshold, and the target value is used to determine the first power threshold.

In one embodiment, the target parameter is used to determine a lower bound of the given power threshold or a higher bound of the given power threshold, where the given power threshold is not less than the lower bound of the given power threshold and is not greater than the higher bound of the given power threshold; the target value is used to determine a lower bound of the first power threshold or a higher bound of the first power threshold, where the first power threshold is not less than the lower bound of the first power threshold, and the first power threshold is not greater than the higher bound of the first power threshold.

In one embodiment, the target parameter comprises a lower bound of the first power threshold or a higher bound of the first power threshold.

In one embodiment, the target parameter comprises power class.

In one embodiment, the target parameter comprises Maximum Power Reduction (MPR).

In one embodiment, the target parameter comprises P_{PowerClass}.

In one embodiment, the target parameter comprises nominal UE power (i.e, no tolerance).

In one embodiment, the target parameter comprises ΔP_{PowerClass}.

In one embodiment, the target parameter comprises adjustment to maximum output power for a given power class.

In one embodiment, the target parameter comprises adjustment to maximum output power.

In one embodiment, the target parameter comprises P_{EMAX,c}.

In one embodiment, the target parameter comprises MPR_{c}.

In one embodiment, the target parameter comprises A-MPR_{c}.

In one embodiment, the target parameter comprises P-MPR_{c}.

In one embodiment, the target parameter comprises a maximum allowed UE output power reduction for serving cell c.

In one embodiment, the target parameter comprises a maximum allowed UE output power reduction.

In one embodiment, the target parameter comprises ΔT_{C,c}.

In one embodiment, the target parameter comprises an allowed operating band edge transmission power relaxation for serving cell c.

In one embodiment, the target parameter comprises an allowed operating band edge transmission power relaxation.

In one embodiment, the target parameter comprises ΔMPR_{c}.

In one embodiment, the target parameter comprises an allowed maximum power reduction relaxation for serving cell c.

In one embodiment, the target parameter comprises an allowed maximum power reduction relaxation.

In one embodiment, the target parameter comprises ΔT_{RxSRS}.

In one embodiment, the target parameter comprises P_{CMAX,f,c}.

In one embodiment, the target parameter comprises P_{CMAX_L,f,c}.

In one embodiment, the target parameter comprises P_{CMAX_H,f,c}.

In one embodiment, for the specific definition of P_{PowerClass}, P_{CMAX,f,c}, the P_{CMAX_L,f,c}, the P_{CMAX_H,f,c}, ΔP_{PowerClass}, P_{EMAX,c}, MPR_{c}, A-MPR_{c}, P-MPR_{c}, ΔT_{C,c}, ΔMPR_{c}, and ΔT_{RxSRS}, refer to chapter 6.2.4 in TS38.101.

In one embodiment, the given reference power value is linearly correlated with the target parameter, and the first power value is linearly correlated with the target value.

In one embodiment, the target parameter comprises at least one of P_{O}_{_{PUSCH}}_{,b,f,c}(j) or a_{b,f,c}(j).

In one embodiment, the target parameter comprises sri-PUSCH-PowerControlId.

In one embodiment, the target parameter comprises sri-PUSCH-ClosedLoopIndex.

In one embodiment, the first receiver receives a second information block; herein, the second information block is used to determine the first candidate value group.

In one subembodiment of the above embodiment, the second information block is used to indicate the first candidate value group.

In one subembodiment of the above embodiment, the second information block explicitly indicates the first candidate value group.

In one subembodiment of the above embodiment, the second information block implicitly indicates the first candidate value group.

In one embodiment, the first receiver transmits a third information block; herein, the third information block is used to determine the first candidate value group.

In one subembodiment of the above embodiment, the third information block belongs to UE capability reporting.

In one subembodiment of the above embodiment, the third information block is used to indicate the first candidate value group.

In one subembodiment of the above embodiment, the third information block explicitly indicates the first candidate value group.

In one subembodiment of the above embodiment, the third information block implicitly indicates the first candidate value group.

In one embodiment, the first candidate value group only comprises the target value, or the first candidate value group comprises N candidate values; N is a positive integer greater than 1.

In one embodiment, the first candidate value group only comprises the target value; or, the first candidate value group comprises a first candidate value and a second candidate value, and the target value is either the first candidate value or the second candidate value.

In one embodiment, at least one reference signal resource in the first reference signal resource set corresponds to one or multiple candidate values of the target parameter, and at least one reference signal resource in the second reference signal resource set corresponds to one or multiple candidate values of the target parameter.

In one embodiment, any reference signal resource in the first reference signal resource set corresponds to one or multiple candidate values of the target parameter, and any reference signal resource in the second reference signal resource set corresponds to one or multiple candidate values of the target parameter.

In one embodiment, at least one reference signal resource in the first reference signal resource set and the second reference signal resource set corresponds to one or multiple candidate values of the target parameter.

Typically, the first reference signal resource corresponds to one or multiple candidate values of the target parameter.

Typically, any candidate value in the first candidate value group is a candidate value of the target parameter corresponding to the first reference signal resource.

Typically, when the first reference signal resource corresponds to only one candidate value of the target parameter, the first candidate value set only comprises the target value; when the first reference signal resource corresponds to multiple candidate values of the target parameter, a first candidate value group comprises multiple candidate values, and the target value is a candidate value in the first candidate value group.

In one embodiment, a given candidate value is a candidate value for the target parameter, and the meaning of the phrase that a given reference signal resource corresponds to the given candidate value comprises: the given reference signal resource is used to determine an antenna port group for transmitting the given signal, and the given candidate value is used to determine transmit power of the given signal.

In one embodiment, a given candidate value is a candidate value for the target parameter, and the meaning of the phrase that a given reference signal resource corresponds to the given candidate value comprises: the given candidate value is configured to the given reference signal resource.

In one embodiment, a given candidate value is a candidate value for the target parameter, and the meaning of the phrase that a given reference signal resource corresponds to the given candidate value comprises: the given candidate value is indicated to the given reference signal resource.

In one embodiment, a given candidate value is a candidate value for the target parameter, and the meaning of the phrase that a given reference signal resource corresponds to the given candidate value comprises: the given candidate value and the given reference signal resource both correspond to a same value.

In one embodiment, a given candidate value is a candidate value for the target parameter, and the meaning of the phrase that a given reference signal resource corresponds to the given candidate value comprises: the given candidate value and the given reference signal resource both correspond to a same parameter.

In one embodiment, the first signaling comprises a first field, a given candidate value is a candidate value for the target parameter, and the meaning of the phrase that a given reference signal resource corresponds to the given candidate value comprises: the given candidate value and the given reference signal resource both correspond to a same candidate value in the first field.

In one embodiment, the first signaling comprises a first field, a given candidate value is a candidate value for the target parameter, and the meaning of the phrase that a given reference signal resource corresponds to the given candidate value comprises: the given candidate value and the given reference signal resource both correspond to a same code-point in the first field.

In one embodiment, the given reference signal resource is the first reference signal resource, the given candidate value is a candidate value of the target parameter corresponding to the first reference signal resource, and the given signal is the first signal.

In one embodiment, the given reference signal resource is the first reference signal resource, the given candidate value is a candidate value in a first candidate value group, and the given signal is the first signal.

In one embodiment, the given reference signal resource is the first reference signal resource, the given candidate value is the target value, and the given signal is the first signal.

In one embodiment, the given reference signal resource is a reference signal resource in the first reference signal resource set, the given candidate value is a candidate value of the target parameter corresponding to the given reference signal resource, and the given signal is the first-type signal.

In one embodiment, the given reference signal resource is a reference signal resource in the second reference signal resource set, the given candidate value is a candidate value of the target parameter corresponding to the given reference signal resource, and the given signal is the second-type signal.

In one embodiment, a code-point of a field corresponds to a value within a value range of the field.

In one embodiment, a code-point of a field is a value within a value range of the field.

In one embodiment, a code-point in a field is a sequence composed of a value of each bit in the field.

In one embodiment, the first candidate value group is indicated by a signaling other than the first signaling.

In one embodiment, the signaling other than the first signaling used to indicate the first candidate value group is a higher-layer signaling.

In one embodiment, the signaling other than the first signaling used to indicate the first candidate value group is an RRC signaling.

In one embodiment, the signaling other than the first signaling used to indicate the first candidate value group is a MAC CE signaling.

In one embodiment, the first candidate value group is indicated by a higher-layer signaling.

In one embodiment, the first candidate value group is configured by a higher-layer signaling.

In one embodiment, the first candidate value group is predefined or configurable.

In one embodiment, the first candidate value group is transmitted by the first node.

In one embodiment, the first candidate value group belongs to capability reporting of the first node.

In one embodiment, capability reporting of the first node is used to determine the first candidate value group.

In one embodiment, the first integer is equal to 1, and the second integer is equal to 2.

In one embodiment, the first integer is equal to 1, and the second integer is greater than 1.

In one embodiment, the first integer is greater than 1, and the second integer is greater than 1.

In one embodiment, when the first condition is not satisfied, the first signaling is used to determine the target value from the first candidate value set.

In one embodiment, when and only when the first condition is not satisfied, the first signaling is used to determine the target value from the first candidate value set.

In one embodiment, when the first condition is satisfied, the first candidate value set only comprises the target value; when the first condition is not satisfied, the first candidate value group also comprises a candidate value other than the target value.

In one embodiment, the meaning of the phrase that the first signaling is used to determine the target value from the first candidate value group comprises: the first signaling is used to indicate the target value from the first candidate value group.

In one embodiment, the meaning of the phrase that the first signaling is used to determine the target value from the first candidate value group comprises: a field comprised in the first signaling is used to indicate the target value from the first candidate value group.

In one embodiment, the meaning of the phrase that the first signaling is used to determine the target value from the first candidate value group comprises: the first signaling is used to explicitly indicate the target value from the first candidate value group.

In one embodiment, the meaning of the phrase that the first signaling is used to determine the target value from the first candidate value group comprises: the first signaling is used to implicitly indicate the target value from the first candidate value group.

In one embodiment, the meaning of the phrase that the first signaling is used to determine the target value from the first candidate value group comprises: information carried by the first signaling is used to determine the target value from the first candidate value group.

In one embodiment, the meaning of the phrase that information carried by the first signaling is used to determine the target value from the first candidate value group comprises: information carried by the first signaling is used to indicate the target value from the first candidate value group.

In one embodiment, the meaning of the phrase that information carried by the first signaling is used to determine the target value from the first candidate value group comprises: information carried by the first signaling corresponds to only the target value in the first candidate value group.

In one embodiment, the meaning of the phrase that the first signaling is used to determine the target value from the first candidate value group comprises: a physical downlink control channel (PDCCH) candidate occupied by the first signaling is used to determine the target value from the first candidate value group.

In one embodiment, the meaning of the phrase that a PDCCH candidate occupied by the first signaling is used to determine the target value from the first candidate value group comprises: a PDCCH candidate occupied by the first signaling corresponds to only the target value in the first candidate value group.

In one embodiment, the meaning of the phrase that a PDCCH candidate occupied by the first signaling is used to determine the target value from the first candidate value group comprises: the first candidate value group comprises N candidate values, and N PDCCH candidate value sets correspond to the N candidate values respectively; a first PDCCH candidate set is a PDCCH candidate set comprising PDCCH candidates occupied by the first signaling among the N PDCCH candidate sets, and the target value is a candidate value corresponding to the first PDCCH candidate set among the N candidate values; N is a positive integer greater than 1.

In one embodiment, the meaning of the phrase that the first signaling is used to determine the target value from the first candidate value group comprises: a CORESET (Control Resource Set) occupied by the first signaling is used to determine the target value from the first candidate value set.

In one embodiment, the meaning of the phrase that a CORESET occupied by the first signaling is used to determine the target value from the first candidate value group comprises: a CORESET occupied by the first signaling corresponds to only the target value in the first candidate value group.

In one embodiment, the meaning of the phrase that a CORESET occupied by the first signaling is used to determine the target value from the first candidate value group comprises: the first candidate value group comprises N candidate values, and N CORESET sets correspond to the N candidate values respectively; a first CORESET set is a CORESET set comprising a CORESET occupied by the first signaling among the N CORESET sets, and the target value is a candidate value corresponding to the first CORESET set among the N candidate values; N is a positive integer greater than 1.

In one embodiment, the meaning of the phrase that the first signaling is used to determine the target value from the first candidate value group comprises: an RNTI (Radio Network Temporary Identifier) used to scramble the first signaling is used to determine the target value from the first candidate value set.

In one embodiment, the meaning of the phrase that an RNTI used for scrambling the first signaling is used to determine the target value from the first candidate value set comprises: an RNTI used to scramble the first signaling corresponds to only the target value in the first candidate value group.

In one embodiment, the meaning of the phrase that an RNTI used for scrambling the first signaling is used to determine the target value from the first candidate value set comprises: the first candidate value group comprises N candidate values, each corresponding to N RNTIs, and the target value is a candidate value corresponding to an RNTI used to scramble the first signaling among the N candidate values; N is a positive integer greater than 1.

In one embodiment, the meaning of the phrase that the first signaling is used to determine the target value from the first candidate value group comprises: the first signaling comprises a first field, and whether the first signaling also comprises a second field is used to determine the target value from the first candidate value set, a name of the second field being the same as a name of the first field.

In one embodiment, the meaning of the phrase that the first signaling is used to determine the target value from the first candidate value group comprises: the first signaling comprises a first field, and whether the first signaling also comprises a second field is used to determine the target value from the first candidate value set, both a name of the second field and a name of the first field comprising SRS resource.

In one embodiment, the meaning of the phrase that the first signaling is used to determine the target value from the first candidate value group comprises: the first signaling comprises a first field, and whether the first signaling also comprises a second field is used to determine the target value from the first candidate value set, both a name of the second field and a name of the first field comprising SRS resource indicator.

In one embodiment, the first candidate value group comprises a first candidate value and a second candidate value; when the first signaling does not comprise the second field, the target value is the first candidate value; when the first signaling comprises the second field, the target value is the second candidate value.

In one embodiment, a name of the second field is the same as a name of the first field.

In one embodiment, both a name of the second field and a name of the first field comprise SRS resource indicator.

In one embodiment, both a name of the second field and a name of the first field both comprise SRS resource.

In one embodiment, the first receiver receives a third information block; herein, the third information block is used to determine whether the first condition is satisfied.

In one embodiment, the first receiver receives a third information block; herein, the third information block is used to indicate whether the first condition is satisfied.

In one embodiment, when the first-type signal and the second-type signal are not overlapping in time domain, the first condition is satisfied; when there exists an overlapping between the first-type signal and the second-type signal in time domain, the first condition is not satisfied.

In one embodiment, when any the first-type signal and the second-type signal are not overlapping in time domain, the first condition is satisfied; when there exists an overlapping between the first-type signal and the second-type signal in time domain, the first condition is not satisfied.

In one embodiment, the meaning of the phrase that the first-type signal and the second-type signal are not overlapping in time domain comprises: any the first-type signal and any the second-type signal are not overlapping in time domain.

In one embodiment, the meaning of the phrase that the first-type signal and the second-type signal are not overlapping in time domain comprises: the first node does not expect the first-type signal and the second-type signal to overlap in time domain.

In one embodiment, the meaning of the phrase that the first-type signal and the second-type signal are not overlapping in time domain comprises: the first node does not expect any the first-type signal and any the second-type signal to overlap in time domain.

In one embodiment, the meaning of the phrase that the first-type signal and the second-type signal are not overlapping in time domain comprises: the first-type signal and the second-type signal are orthogonal in time domain.

In one embodiment, the meaning of the phrase that the first-type signal and the second-type signal are not overlapping in time domain comprises: any the first-type signal and any the second-type signal are orthogonal in time domain.

In one embodiment, the phrase of being overlapping in time domain comprises: being partially or fully overlapping in time domain.

In one embodiment, the phrase of being overlapping in time domain comprises: comprising at least one same symbol in time domain.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multi-carrier symbol is a Filter Bank Multi-Carrier (FBMC) symbol.

In one embodiment, the multicarrier symbol comprises a Cyclic Prefix (CP).

### Embodiment 2

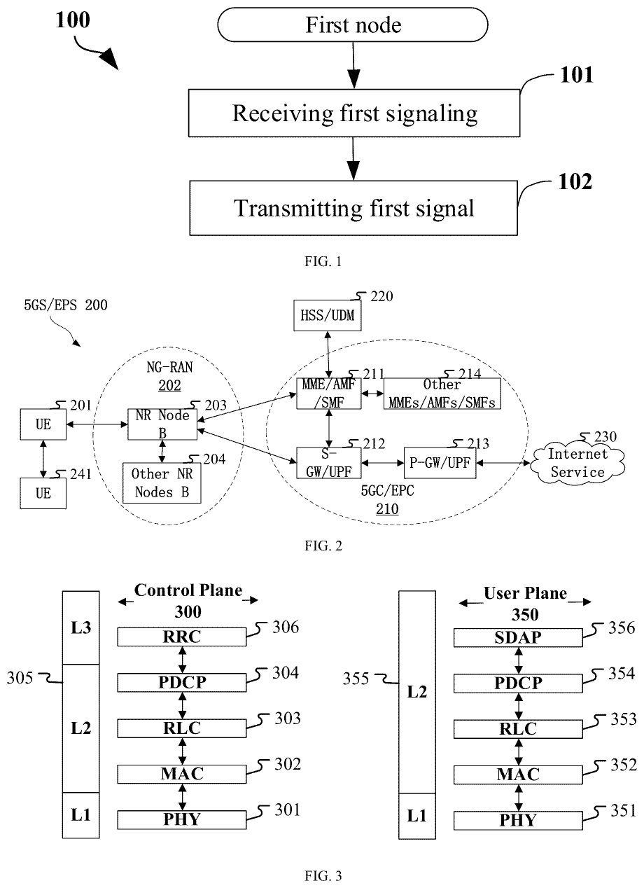

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

### Embodiment 3

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling is generated by the PHY 301 or the PHY 351.

In one embodiment, the first signal is generated at the PHY 301 or the PHY 351.

In one embodiment, the first-type signal is generated by the PHY 301 or the PHY 351.

In one embodiment, the second-type signal is generated by the PHY 301 or the PHY 351.

In one embodiment, the first information block is generated by the PHY 301 or the PHY 351.

In one embodiment, the first information block is generated by the MAC sublayer 302 or the MAC sublayer 352.

In one embodiment, the first information block is generated by the RLC sublayer 303 or the MAC sublayer 353.

In one embodiment, the first information block is generated by the PDCP sublayer 304 or the MAC sublayer 354.

In one embodiment, the first information block is generated by the RRC sublayer 306 or the SDAP sublayer 356.

### Embodiment 4

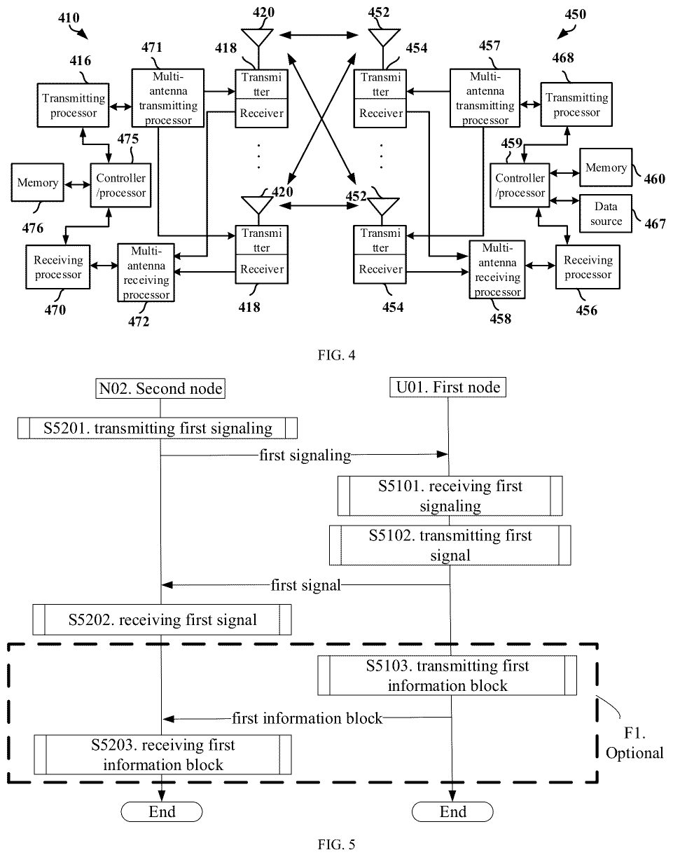

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling; transmits a first signal; herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the second communication device 450 comprises a memory that stores a computer readable instruction program. The computer readable instruction program generates an action when executed by at least one processor. The action includes: receiving a first signaling; and transmitting a first signal; herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first signaling; and receives a first signal; herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first communication device 410 comprises a memory that stores a computer readable instruction program. The computer readable instruction program generates an action when executed by at least one processor. The action includes: transmitting a first signaling; and receiving a first signal; herein, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first signaling in the present application; at least one of the antenna 420, the transmitter 418, the transmitting processor 416, the multi-antenna transmitting processor 471, the controller/processor 475, or the memory 476 is used to transmit the first signaling in the present application.

In one embodiment, at least one of the antenna 452, the transmitter 454, the transmitting processor 468, the multi-antenna transmitting processor 457, the controller/processor 459, or the memory 460 is used to transmit the first signal in the present application; at least one of the antenna 420, the receiver 418, the receiving processor 470, the multi-antenna receiving processor 472, the controller/processor 475, or the memory 476 is used to receive the first signal in the present application.

In one embodiment, at least one of the antenna 452, the transmitter 454, the transmitting processor 468, the multi-antenna transmitting processor 457, the controller/processor 459, or the memory 460 is used to transmit the first information block in the present application; at least one of the antenna 420, the receiver 418, the receiving processor 470, the multi-antenna receiving processor 472, the controller/processor 475, or the memory 476 is used to receive the first information block in the present application.

### Embodiment 5

Embodiment 5 illustrates a flowchart of wireless transmission according to one embodiment in the present application, as shown in FIG. 5. In FIG. 5, a first node U01 and a second node N02 are respectively two communication nodes transmitted via an air interface; In FIG. 5, steps in box F1 are optional.

The first node U01 receives a first signaling in step S5101, and transmits a first signal in step S5102; transmits a first information block in step S5103;
the second node N02 transmits a first signaling in step S5201; receives a first signal in step S5202; receives a first information block in step S5203.

In embodiment 5, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used by the first node U01 to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used by the first node U01 to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

In one embodiment, the first information block comprises at least one power difference value, and the first power difference value is a power difference value in the first information block.

In one embodiment, the first information block comprises a power headroom report.

In one embodiment, the first power difference value is a non-negative real number.

In one embodiment, the first information block comprises at least one power difference value, and any power difference value in the first information block is a non-negative real number.

In one embodiment, the transmit power of the first signal is not greater than the first power threshold.

In one embodiment, the first power threshold is configured maximum output power.

In one embodiment, the first power threshold is maximum output power of the first signal.

Typically, transmit power of the first signal is measured by dBm, the first power threshold is measured by dBm, and the first power difference value is measured by dB.

Typically, any power difference value in the first information block is measured by dB.

In one embodiment, the first power threshold is related to the target parameter.

In one embodiment, the first power threshold is related to a candidate value of the target parameter.

In one embodiment, the first power threshold is related to the first candidate value group.

In one embodiment, the first power threshold is related to the target value.

In one embodiment, the first power threshold is equal to the target value, and the transmit power of the first signal is not greater than the first power threshold and not greater than the first power value.

In one embodiment, the first power threshold is equal to the target value, and transmit power of the first signal is a minimum value of the first power threshold and the first power value.

In one embodiment, the target parameter is used to determine the first power threshold.

In one embodiment, the target parameter is used to determine a lower bound of the first power threshold or a higher bound of the first power threshold, where the first power threshold is not less than the lower bound of the first power threshold, and the first power threshold is not greater than the higher bound of the first power threshold.

In one embodiment, the first power threshold is a candidate value for the target parameter.

In one embodiment, the first power threshold is the target value.

In one embodiment, the target value is used to determine the first power threshold.

In one embodiment, the first power threshold is a candidate value in the first candidate value group.

In one embodiment, a candidate value in the first candidate value group is used to determine the first power threshold.

In one embodiment, the first power threshold is predefined.

In one embodiment, the first power threshold is configurable.

In one embodiment, the first power threshold is maximum transmit power on a carrier, transmission occasion, and a serving cell corresponding to the first signal.

In one embodiment, the first power threshold is P_{CMAX,f,c}(i).

In one embodiment, for the specific definition of the P_{CMAX,f,c}(i), refer to chapter 7.1.1 in TS38.213.

In one embodiment, the first power threshold is P_{CMAX,f,c}.

In one embodiment, a lower limit of the first power threshold is P_{CMAX_L,f,c}, and a higher limit of the first power threshold is P_{CMAX_H,f,c}.

In one embodiment, the first power threshold is related to whether the first condition is satisfied.

In one embodiment, the meaning of the phrase that “the first power threshold is related to whether the first condition is satisfied” comprises: when the first condition is satisfied, the first power threshold is the first threshold; when the first condition is not satisfied, the first power threshold is a threshold in a reference threshold group, the reference threshold comprises multiple thresholds, and any threshold in the reference threshold group is a non-negative real number.

In one embodiment, the meaning of the phrase that “the first power threshold is related to whether the first condition is satisfied” comprises: when the first condition is satisfied, the first power threshold is a first threshold; when the first condition is not satisfied, the first power threshold is a second threshold.

In one embodiment, the first threshold and the second threshold are different.

In one embodiment, the first threshold and the second threshold are respectively predefined or configured.

In one embodiment, the first threshold and the second threshold are respectively determined.

In one embodiment, the first threshold and the reference threshold group are predefined or configured.

In one embodiment, the first threshold and the reference threshold group are respectively determined.

In one embodiment, the first threshold is a threshold in the reference threshold group.

In one embodiment, a number of power difference value(s) comprised in the first information block is related to whether the first condition is satisfied.

In one embodiment, when the first condition is satisfied, a fifth integer is a number of power difference value(s) comprised in the first information block; when the first condition is not satisfied, a sixth integer is a number of power difference value(s) comprised in the first information block, and the sixth integer is greater than the fifth integer.

In one embodiment, the fifth integer is equal to 1, and the sixth integer is greater than 1.

In one embodiment, the fifth integer is equal to 1, and the sixth integer is equal to 2.

In one embodiment, the fifth integer is equal to 1, and the sixth integer is equal to 3.

In one embodiment, when the first condition is not satisfied, the first information block comprises a second power difference value, and the second power difference value is related to transmit power of the second signal.

In one embodiment, when the first condition is not satisfied, the first information block comprises a second power difference value, and the second power difference value is equal to a difference obtained by subtracting the transmit power of the second signal from the second power threshold.

In one embodiment, the second power threshold is measured by dBm.

In one embodiment, the second power threshold is maximum output power of the second signal.

### Embodiment 6

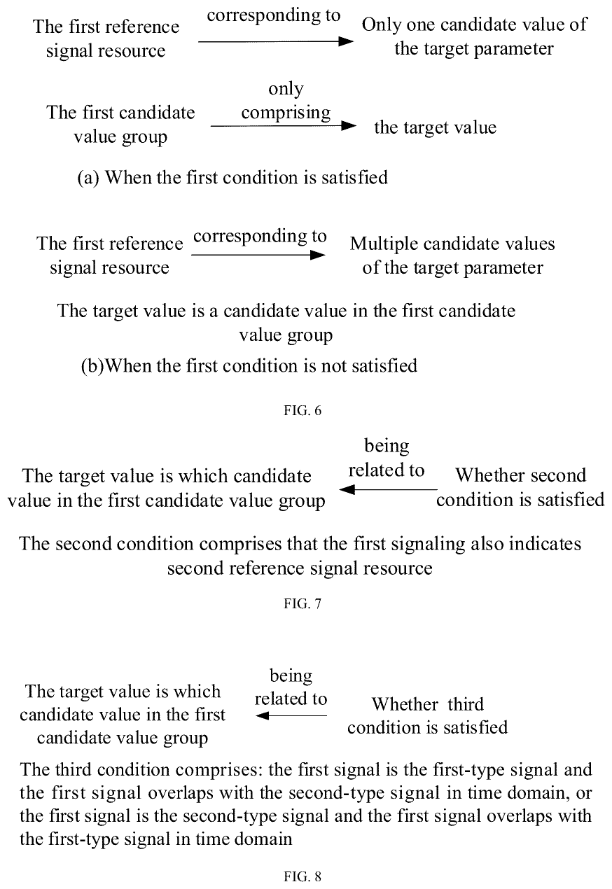

Embodiment 6 illustrate a schematic diagram of relations among a first candidate value group, a target value and a first condition according to one embodiment of the present application; as shown in FIG. 6.

In embodiment 6, the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

### Embodiment 7

Embodiment 7 illustrates a schematic diagram of a determination of a target value according to one embodiment of the present application, as shown in FIG. 7.

In embodiment 7, when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set.

In one embodiment, the second reference signal resource is used to determine an antenna port group for transmitting a second signal, and both the first signal and the second signal are scheduled by the first signaling.

In one embodiment, the second reference signal resource is used to determine an antenna port group for transmitting a second signal, both the first signal and the second signal are scheduled by the first signaling, and the first signal and the second signal occupy same time-frequency resources.

In one embodiment, the second reference signal resource is used to determine an antenna port group for transmitting a second signal, both the first signal and the second signal are scheduled by the first signaling, and time-frequency resources occupied by the first signal and time-frequency resources occupied by the second signal are overlapping.

In one embodiment, the second reference signal resource is used to determine an antenna port group for transmitting a second signal, both the first signal and the second signal are scheduled by the first signaling, and the first signal and the second signal are overlapping in time domain.

In one embodiment, the meaning of the phrase that “the target value being which candidate value in the first candidate value group is related to whether a second condition is satisfied” comprises: when the first condition is not satisfied, the first candidate value group comprises a first candidate value and a second candidate value; when the second condition is not satisfied, the target value is the first candidate value; when the second condition is satisfied, the target value is the second candidate value.

In one embodiment, the meaning of the phrase that “the target value being which candidate value in the first candidate value group is related to whether the second condition is satisfied” comprises: the first candidate value group comprises N candidate values, where N is a positive integer greater than 1; when the second condition is not satisfied, the target value is a first candidate value among the N candidate values; when the second condition is satisfied, the target value is a second candidate value among the N candidate values; the first candidate value is one of the N candidate values, and the second candidate value is one of the N candidate values.

In one embodiment, the meaning of the phrase that “the first signaling also indicates a second reference signal resource” comprises: the first signaling comprises a first field and a second field, and the first field and the second field in the first signaling respectively indicate the first reference signal resource and the second reference signal resource.

In one embodiment, the meaning of the phrase that “the first signaling also indicates a second reference signal resource” comprises: the first signaling indicates the first reference signal resource from the first reference signal resource set and the first signaling indicates the second reference signal resource from the second reference signal resource set; or, the first signaling indicates the first reference signal resource from the second reference signal resource set and the first signaling indicates the second reference signal resource from the first reference signal resource set.

In one embodiment, when the first signaling also indicates a second reference signal resource, the second condition is satisfied; when the first signaling only indicates the first reference signal resource from the first reference signal resource set or the second reference signal resource set, the second condition is not satisfied.

In one embodiment, when the first signaling comprises a first field and a second field, the first field and the second field in the first signaling respectively indicate the first reference signal resource and the second reference signal resource, and the second condition is satisfied; when the first signaling comprises a first field and does not comprise a second field, the first field in the first signaling indicates the first reference signal resource, and the second condition is satisfied.

### Embodiment 8

Embodiment 8 illustrates a schematic diagram of a determination of a target value according to another embodiment of the present application, as shown in FIG. 8.

In embodiment 8, when the first condition is not satisfied, the target value being related to which candidate value in the first candidate value group is related to whether a third condition is satisfied; the third condition comprises: the first signal is the first-type signal and the first signal and the second-type signal are overlapping in time domain, or the first signal is the second-type signal and the first signal and the first-type signal are overlapping in time domain.

In one embodiment, the meaning of the phrase that “the target value being which candidate value in the first candidate value group is related to whether the third condition is satisfied” comprises: when the first condition is not satisfied, the first candidate value group comprises a first candidate value and a second candidate value; when the third condition is not satisfied, the target value is the first candidate value; when the third condition is satisfied, the target value is the second candidate value.

In one embodiment, the meaning of the phrase that “the target value being which candidate value in the first candidate value group is related to whether the third condition is satisfied” comprises: the first candidate value group comprises N candidate values, where N is a positive integer greater than 1; when the third condition is not satisfied, the target value is a first candidate value among the N candidate values; when the third condition is satisfied, the target value is a second candidate value among the N candidate values; the first candidate value is one of the N candidate values, and the second candidate value is one of the N candidate values.

In one embodiment, when the first signal is the first-type signal and the first signal and the second-type signal are overlapping in time domain, or the first signal is the second-type signal and the first signal and the first-type signal are overlapping in time domain, the third condition is satisfied, when the first signal is the first-type signal and there does not exist the second-type signal being overlapping with the first signal in time domain, or the first signal is the second-type signal and there does not exist the first-type signal being overlapping with the first signal in time domain, the third condition is not satisfied.

In one embodiment, when the first signal is the first-type signal and the first signal and the second-type signal are overlapping in time domain, or the first signal is the second-type signal and the first signal and the first-type signal are overlapping in time domain, the third condition is satisfied, when there does not exist the first-type signal or the second-type signal being overlapping with the first signal in time domain, the third condition is not satisfied.

### Embodiment 9

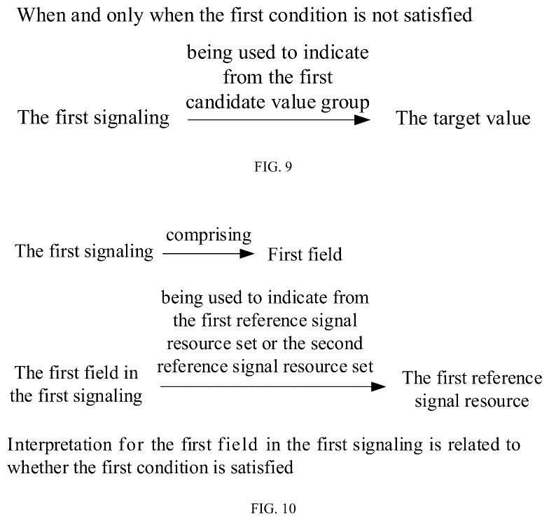

Embodiment 9 illustrates a schematic diagram of a determination of a target value according to another embodiment of the present application, as shown in FIG. 9.

In embodiment 9, when and only when the first condition is not satisfied, the first signaling is used to indicate the target value from the first candidate value set.

In one embodiment, whether the first signaling is used to indicate the target value is related to whether the first condition is satisfied.

In one embodiment, whether the first signaling is used to indicate the target value from the first candidate value group is related to whether the first condition is satisfied.

In one embodiment, when the first condition is satisfied, the target value is indicated by a signaling other than the first signaling.

In one embodiment, when the first condition is satisfied, the target value is not indicated by the first signaling.

In one embodiment, when the first condition is satisfied, the target value is indicated by a signaling other than the first signaling from the first candidate value.

In one embodiment, when the first condition is satisfied, the target value is not indicated by the first signaling from the first candidate value.

In one embodiment, the first candidate value group is indicated by a signaling other than the first signaling; when the first condition is satisfied, the first candidate value set only comprises the target value; when the first condition is not satisfied, the first candidate value group also comprises a candidate value other than the target value, and the first signaling is used to indicate the target value from the first candidate value group.

In one embodiment, the first candidate value group is indicated by a signaling other than the first signaling; when the first condition is satisfied, the first candidate value set only comprises the target value; when the first condition is not satisfied, the first candidate value group comprises a first candidate value and a second candidate value, and the target value is either the first candidate value or the second candidate value, and the first signaling is used to indicate the target value from the first candidate value group.

In one embodiment, a field comprised in the first signaling is used to indicate the target value from the first candidate value group.

In one embodiment, a field comprised in the first signaling indicates an index of the target value in the first candidate value group.

In one embodiment, an Open-loop power control parameter set indication field comprised in the first signaling is used to indicate the target value from the first candidate value set.

In one embodiment, for the specific definition of the Open-loop power control parameter set indication field, refer to chapter 7.3.1 of 3GPP TS 38.212.

### Embodiment 10

Embodiment 10 illustrates a schematic diagram of a relation between a first field and a first condition according to one embodiment of the present application, as shown in FIG. 10.

In embodiment 10, the first signaling comprises a first field, and the first field in the first signaling is used to indicate the first reference signal resource from the first reference signal resource set or the second reference signal resource set; an interpretation of the first field in the first signaling is related to whether the first condition is satisfied.

In one embodiment, the first field comprises at least one bit.

In one embodiment, the first field is an SRS resource indicator field.

In one embodiment, for the specific definition of the SRS resource indicator field, refer to chapter 7. 3. 1 in 3GPP TS38. 212.

In one embodiment, the first reference signal resource belongs to the first reference signal resource set and the first field in the first signaling indicates an index of the first reference signal resource in the first reference signal resource set, or the first reference signal resource belongs to the second reference signal resource set and the first field in the first signaling indicates an index of the first reference signal resource in the second reference signal resource set.

In one embodiment, the first signaling comprises a third field, the third field in the first signaling indicates whether the first field in the first signaling is used to indicate the first reference signal resource from the first reference signal resource set or the first reference signal resource from the second reference signal resource set.

In one embodiment, the third field is SRS resource set indicator.

In one embodiment, the third field comprises 2 bits.

In one embodiment, the third field comprises at least one bit.

In one embodiment, the third field comprises 1 bit.

In one embodiment, the meaning of the phrase that an interpretation for the first field in the first signaling is related to whether the first condition is satisfied comprises: an interpretation for the first field in the first signaling when the first condition is satisfied is different from an interpretation for the first field in the first signaling when the first condition is not satisfied.

In one embodiment, the meaning of the phrase that an interpretation for the first field in the first signaling is related to whether the first condition is satisfied comprises: a size of the first field in the first signaling is related to whether the first condition is satisfied.

In one embodiment, the meaning of the phrase that a size of the first field in the first signaling is related to whether the first condition is satisfied comprises: a size of the first field in the first signaling when the first condition is satisfied is different from a size of the first field in the first signaling when the first condition is not satisfied.

In one embodiment, the meaning of the phrase that a size of the first field in the first signaling is related to whether the first condition is satisfied comprises: a size of the first field in the first signaling when the first condition is satisfied and a size of the first field in the first signaling when the first condition is not satisfied are respectively determined.

In one embodiment, the meaning of the phrase that an interpretation for the first field in the first signaling is related to whether the first condition is satisfied comprises: information indicated by at least one code-point comprised in the first field is related to whether the first condition is satisfied.

In one embodiment, the meaning of the phrase that information indicated by at least one code-point comprised in the first field is related to whether the first condition is satisfied comprises: information indicated by at least one code-point in the first field when the first condition is satisfied is different from information indicated by at least one code-point in the first field when the first condition is not satisfied.

In one embodiment, the meaning of the phrase that information indicated by at least one code-point comprised in the first field is related to whether the first condition is satisfied comprises: information indicated by at least one code-point in the first field when the first condition is satisfied and information indicated by at least one code-point in the first field when the first condition is not satisfied are predefined or configured, respectively.

In one embodiment, the meaning of the phrase that an interpretation for the first field in the first signaling is related to whether the first condition is satisfied comprises: information indicated by the first field is related to whether the first condition is satisfied.

In one embodiment, the meaning of the phrase that information indicated by the first field is related to whether the first condition is satisfied comprises: information indicated by the first field when the first condition is satisfied is different from information indicated by the first field when the first condition is not satisfied.

In one embodiment, the meaning of the phrase that information indicated by the first field is related to whether the first condition is satisfied comprises: information indicated by the first field when the first condition is satisfied and information indicated by the first field when the first condition is not satisfied are predefined or configured, respectively.

In one embodiment, the meaning of the phrase that an interpretation for the first field in the first signaling is related to whether the first condition is satisfied comprises: whether reference signal resources indicated by the first field in the first signaling is in the first reference signal resource set or the second reference signal resource set is related to whether the first condition is satisfied.

In one embodiment, the meaning of the phrase that whether reference signal resources indicated by the first field in the first signaling is in the first reference signal resource set or the second reference signal resource set is related to whether the first condition is satisfied comprises: when the first condition is not satisfied, the first field in the first signaling indicates reference signal resources in the first reference signal resource set; when the first condition is satisfied, the first field in the first signaling indicates reference signal resources in either the first reference signal resource set or the second reference signal resource set.

In one embodiment, the meaning of the phrase that whether reference signal resources indicated by the first field in the first signaling is in the first reference signal resource set or the second reference signal resource set is related to whether the first condition is satisfied comprises: when the first condition is not satisfied, the first field in the first signaling indicates reference signal resources in the first reference signal resource set; when the first condition is satisfied, the first field in the first signaling indicates reference signal resources in the second reference signal resource set.

### Embodiment 11

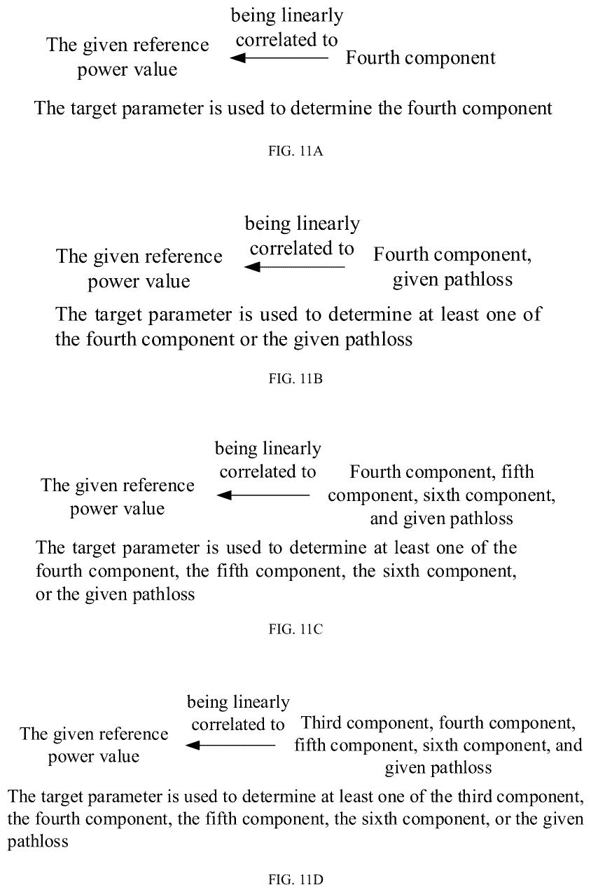

Embodiment 11 illustrates a schematic diagram of a given reference power value according to one embodiment of the present application, as shown in FIGS. 11A-11D.

In embodiment 11A, the given reference power value is linearly correlated to a fourth component, and the target parameter is used to determine the fourth component.

In embodiment 11B, the given reference power value is linearly correlated to both a fourth component and a given pathloss, and the target parameter is used to determine at least one of the fourth component or the given pathloss.

In embodiment 11C, the given reference power value is linearly correlated to a fourth component, a fifth component, a sixth component, and given pathloss, and the target parameter is used to determine at least one of the fourth component, the fifth component, the sixth component, or the given pathloss.

In embodiment 11D, the given reference power value is linearly correlated to a third component, a fourth component, a fifth component, a sixth component, and given pathloss, and the target parameter is used to determine at least one of the third component, the fourth component, the fifth component, the sixth component, or the given pathloss.

In one embodiment, the given signal is the first signal, and the given reference power value is the first power value.

In one embodiment, the given signal is either the first-type signal or the second-type signal.

Typically, a linear coefficient of the given reference power value and the third component is 1, a linear coefficient of the given reference power value and the fourth component is 1, a linear coefficient of the given reference power value and the fifth component is 1, and a linear coefficient of the given reference power value and the sixth component is 1.

In one embodiment, the given reference power value P₁ is: P₁=p₄+p₆+b₂p₂+p₅; where p₄, p₆, p₂, b₂, and p₅ are respectively the fourth component, the sixth component, the given pathloss, a linear coefficient of the given reference power value and the given circuit loss, and a fifth component.

In one embodiment, the given reference power value P₁ is: P₁=p₄+p₆+b₂p₂+p₅+p₃; where p₄, p₆, p₂, b₂, p₅ and p₃ are respectively the fourth component, the sixth component, the given pathloss, a linear coefficient of the given reference power value and the given pathloss, a fifth component and the third component.

In one embodiment, the target parameter comprises the fourth component.

In one embodiment, the target parameter comprises the sixth component.

In one embodiment, the target parameter comprises the given pathloss.

In one embodiment, the target parameter comprises a linear coefficient of the given reference power value and the given pathloss.

In one embodiment, the target parameter comprises the fifth component.

In one embodiment, the target parameter comprises the third component.

In one embodiment, the fourth component is linearly correlated with the target parameter.

In one embodiment, the sixth component is linearly correlated with the target parameter.

In one embodiment, the fifth component is linearly correlated with the target parameter.

In one embodiment, the third component is linearly correlated with the target parameter.

In one embodiment, a linear coefficient of the given reference power value and the given pathloss is configured by higher-layer parameters.

In one embodiment, a linear coefficient of the given reference power value and the given pathloss is pre-defined.

In one embodiment, a linear coefficient of the given reference power value and the fourth component is 1.

In one embodiment, a linear coefficient of the given reference power value and the sixth component is a real number.

In one embodiment, a linear coefficient of the given reference power value and the sixth component is 1.

In one embodiment, the sixth component is 10 log₁₀(2^{μ}M_{RB,b,f,c}^{PUSCH}(i)).

In one embodiment, for the specific meaning of the 10 log₁₀(2^{μ}M_{RB,b,f,c}^{PUSCH}(i)), refer to chapter 7.1.1 in TS38. 213.

In one embodiment, a size of frequency-domain resources occupied by the given signal is a bandwidth occupied by the given signal.

In one embodiment, a size of frequency-domain resources occupied by the given signal is a number of resource block(s) occupied by the given signal.

In one embodiment, a size of frequency-domain resources occupied by the given signal is a number of subcarrier(s) occupied by the given signal.

In one embodiment, a linear value of the sixth component is equal to a product of a size of frequency-domain resources occupied by the given signal and 2^{μ}, where 2^{μ} is equal to a subcarrier spacing of a subcarrier occupied by the given signal divided by 15 kHz.

In one subembodiment of the above embodiment, a subcarrier spacing of a subcarrier occupied by the given signal is equal to 15 kHz, μ is equal to 0, and the 2^{μ} is equal to 1.

In one subembodiment of the above embodiment, a subcarrier spacing of a subcarrier occupied by the given signal is equal to 30 kHz, μ is equal to 1, and the 2^{μ} is equal to 2.

In one subembodiment of the above embodiment, a subcarrier spacing of a subcarrier occupied by the given signal is equal to 60 kHz, μ is equal to 2, and the 2^{μ} is equal to 4.

In one subembodiment of the above embodiment, a subcarrier spacing of a subcarrier occupied by the given signal is equal to 120 kHz, μ is equal to 3, and the 2^{μ} is equal to 8.

In one subembodiment of the above embodiment, a subcarrier spacing of a subcarrier occupied by the given signal is equal to 240 kHz, μ is equal to 4, and the 2^{μ} is equal to 16.

In one embodiment, the third component is PUSCH power control adjustment.

In one embodiment, the third component is a sum of a set of TPC (Transmit Power Control) command values.

In one embodiment, a linear coefficient of the given reference power value and the third component is a real number.

In one embodiment, a linear coefficient of the given reference power value and the third component is 1.

In one embodiment, the third component is f_{b,f,c}(i,l).

In one embodiment, for the specific definition of the f_{b,f,c}(i,l), refer to chapter 7.1.1 in 3GPP TS38. 213.

In one embodiment, the fourth component is target received power of the given signal.

In one embodiment, the fourth component is measured by dBm.

In one embodiment, a linear coefficient of the given reference power value and the fourth component is 1.

In one embodiment, the fourth component is P_{O_PUSCH,b,f,c}(j).

In one embodiment, for the specific definition of the P_{O_PUSCH,b,f,c}(j), refer to chapter 7.1.1 in 3GPP TS38. 213.

In one embodiment, the fourth component is a sum of the first sub-component and a second sub-component.

In one embodiment, the fourth component is P_{O_PUSCH,b,f,c}(j), the P_{O_PUSCH,b,f,c}(j) is a sum of P_{O_NOMINAL_PUSCH,f,c}(j) and P_{O_UE_PUSCH,b,f,c}(j).

In one embodiment, for the specific definition of the P_{O_PUSCH,b,f,c}(j), the P_{O_NOMINAL_PUSCH,f,c}(j), and P_{O_UE_PUSCH,b,f,c}(j), refer to chapter 7.1.1 in 3GPP TS38. 213.

In one embodiment, a linear coefficient of the given reference power value and the fifth component is a real number.

In one embodiment, a linear coefficient of the given reference power value and the fifth component is 1.

In one embodiment, the fifth component is a real number.

In one embodiment, the fifth component is a non-negative real number.

In one embodiment, the fifth component is equal to 0.

In one embodiment, the fifth component is not equal to 0.

In one embodiment, the fifth component is related to a number of layer(s) of the given signal.

In one embodiment, the fifth component is related to an MCS of the given signal.

In one embodiment, the fifth component is related to a number of code blocks of the given signal and a size of each code block.

In one embodiment, the fifth component is Δ_{TF,b,f,c}(i).

In one embodiment, for the specific meaning of the Δ_{TF,b,f,c}(i), refer to chapter 7.1.1 in 3GPP TS38. 213.

In one embodiment, the fifth component is Δ_{TF,b,f,c}(i).

In one embodiment, the fifth component Δ_{TF,b,f,c}(i) is Δ_{TF,b,f,c}(i)=10 log₁₀((2^{BPRE·K}^{_{S}}−1)·β_{offset}^{PUSCH}); herein, BPRE=Σᵣ₌₀^{C-1}Kᵣ/N_{RE}, where Kᵣ is a size of code block r, C is a number of transmitted code blocks, and the second given value is N_{RE}.

### Embodiment 12

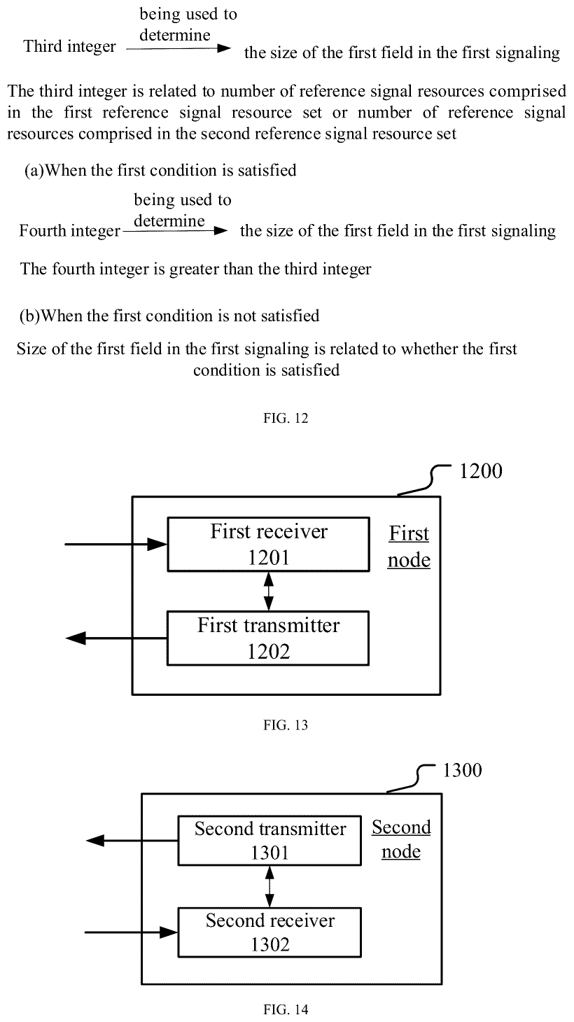

Embodiment 12 illustrate a schematic diagram of a relation between an interpretation for a first field in a first signaling and a first condition according to one embodiment of the present application, as shown in FIG. 12.

In embodiment 12, a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

In one embodiment, when the first condition is satisfied, there are no two code-points in the first field indicating a same reference signal resource in the first reference signal resource set; when the first condition is not satisfied, there are two code-points in the first field indicating a same reference signal resource in the first reference signal resource set.

In one embodiment, when the first condition is satisfied, M1 code-points in the first field respectively indicate M1 reference signal resources in the first reference signal resource set, or M2 code-points in the first field respectively indicate M2 reference signal resources in the second reference signal resource set.

In one subembodiment of the above embodiment, the third integer is equal to either M1 or M2.

In one subembodiment of the above embodiment, the third integer is not less than M1 or M2.

In one subembodiment of the above embodiment, M1 is equal to a number of reference signal resource(s) comprised in the first reference signal resource set.

In one subembodiment of the above embodiment, M2 is equal to a number of reference signal resource(s) comprised in the second reference signal resource set.

In one subembodiment of the above embodiment, there are no 2 code-points in the M1 code-points of the first field indicating a same reference signal resource in the first reference signal resource set, or there are no 2 code-points in the M2 code-points of the first field indicating a same reference signal resource in the second reference signal resource set.

In one embodiment, when the first condition is not satisfied, M3 code-points in the first field respectively indicate M3 pairs of a reference signal resource in the first reference signal resource set and a candidate value of the corresponding target parameter, or M4 code-points in the first field respectively indicate M4 pairs of a reference signal resource in the second reference signal resource set and a candidate value of the corresponding target parameter.

In one subembodiment of the above embodiment, the first candidate value group comprises N candidate values, and the N pairs in the M3 pairs of a reference signal resource in the first reference signal resource set and a candidate value of the corresponding target parameter respectively comprise the N candidate values and all the N pairs comprise the first reference signal resource.

In one subembodiment of the above embodiment, the first candidate value group comprises a first candidate value and a second candidate value, and two pairs of the M3 pairs of a reference signal resource in the first reference signal resource set and a candidate value of the corresponding target parameter are respectively the first reference signal resource and the first candidate value as well as the first reference signal resource and the second candidate value.

In one subembodiment of the above embodiment, the fourth integer is equal to M3 and M4.

In one subembodiment of the above embodiment, the fourth integer is not less than M3 and M4.

In one subembodiment of the above embodiment, M3 is greater than a number of reference signal resource(s) comprised in the first reference signal resource set.

In one subembodiment of the above embodiment, M4 is greater than a number of reference signal resource(s) comprised in the second reference signal resource set.

In one subembodiment of the above embodiment, there exist two code-points in the M3 code-points of the first field indicating a same reference signal resource in the first reference signal resource set, or there exist two code-points in the M4 code-points of the first field indicating a same reference signal resource in the second reference signal resource set.

In one embodiment, the meaning of the phrase that a third integer is used to determine the size of the first field in the first signaling comprises: the size of the first field in the first signaling is equal to a smallest integer of base 2 logarithm not less than the third integer; the meaning of the phrase that a fourth integer is used to determine the size of the first field in the first signaling comprises: the size of the first field in the first signaling is equal to a smallest integer of base 2 logarithm not less than the fourth integer.

In one embodiment, the meaning of the phrase that a third integer is used to determine the size of the first field in the first signaling comprises: a number of code-points comprised by the first field in the first signaling is not less than the third integer; the meaning of the phrase that a fourth integer is used to determine the size of the first field in the first signaling comprises: a number of code-points comprised by the first field in the first signaling is not less than the fourth integer.

In one embodiment, the meaning of the phrase that a third integer is used to determine the size of the first field in the first signaling comprises: the third integer is a, and the size of the first field in the first signaling is ┌log₂(a)┐; the meaning of the phrase that a fourth integer is used to determine the size of the first field in the first signaling comprises: the third integer is b, and the size of the first field in the first signaling is ┌Log₂(b)┐.

In one embodiment, the third integer is N_{SRS}; when the first condition is satisfied, the size of the first field in the first signaling is ┌log₂(N_{SRS})┐.

In one embodiment, for specific meanings of the N_{SRS} and the ┌log₂(N_{SRS})┐, refer to chapter 7.3.1 in 3GPP TS 38.212.

In one embodiment, the meaning of the phrase that the third integer is related to a number of reference signal resource(s) comprised in the first reference signal resource set or a number of reference signal resource(s) comprised in the second reference signal resource set comprises: a number of reference signal resource(s) comprised in the first reference signal resource set or a number of reference signal resource(s) comprised in the second reference signal resource set is used to determine the third integer.

In one embodiment, the meaning of the phrase that the third integer is related to a number of reference signal resource(s) comprised in the first reference signal resource set or a number of reference signal resource(s) comprised in the second reference signal resource set comprises: the third integer is equal to a number of reference signal resources comprised in the first reference signal resource set or a number of reference signal resources comprised in the second reference signal resource set.

In one embodiment, the meaning of the phrase that the third integer is related to a number of reference signal resource(s) comprised in the first reference signal resource set or a number of reference signal resource(s) comprised in the second reference signal resource set comprises: when the first field in the first signaling is used to indicate the first reference signal resource from the first reference signal resource set, and the third integer is equal to a number of reference signal resource(s) comprised in the first reference signal resource set; when the first field in the first signaling is used to indicate the first reference signal resource from the second reference signal resource set, and the third integer is equal to a number of reference signal resource(s) comprised in the second reference signal resource set.

In one embodiment, the meaning of the phrase that the third integer is related to a number of reference signal resource(s) comprised in the first reference signal resource set or a number of reference signal resource(s) comprised in the second reference signal resource set comprises: the first field in the first signaling is used to indicate the first reference signal resource from the first reference signal resource set, and the third integer is equal to a number of reference signal resource(s) comprised in the first reference signal resource set.

In one embodiment, the meaning of the phrase that the third integer is related to a number of reference signal resource(s) comprised in the first reference signal resource set or a number of reference signal resource(s) comprised in the second reference signal resource set comprises: the first field in the first signaling is used to indicate the first reference signal resource from the second reference signal resource set, and the third integer is equal to a number of reference signal resource(s) comprised in the second reference signal resource set.

In one embodiment, the fourth integer is equal to twice the third integer.

In one embodiment, the fourth integer is not greater than twice the third integer.

In one embodiment, the fourth integer is equal to a positive integral multiple of the third integer.

### Embodiment 13

Embodiment 13 illustrates a structure block diagram of a processor in a first node according to one embodiment of the present application, as shown in FIG. 13. In FIG. 13, a processor 1200 in a first node comprises a first receiver 1201 and a first transmitter 1202.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in Embodiment 4.

In one embodiment, the first transmitter 1202 comprises at least one of the antenna 452, the transmitter 454, the transmitting processor 468, the multi-antenna transmitting processor 457, the controller/processor 459, the memory 460, or the data source 467 in Embodiment 4.

The first receiver 1201 receives a first signaling; and
the first transmitter 1202 transmits a first signal;

In embodiment 13, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

In one embodiment, when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set.

In one embodiment, when and only when the first condition is not satisfied, the first signaling is used to indicate the target value from the first candidate value set.

In one embodiment, the first signaling comprises a first field, and the first field in the first signaling is used to indicate the first reference signal resource from the first reference signal resource set or the second reference signal resource set; an interpretation of the first field in the first signaling is related to whether the first condition is satisfied.

In one embodiment, a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

In one embodiment, the first transmitter 1202 transmits a first information block; herein, the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

### Embodiment 14

Embodiment 14 illustrates a structure block diagram of a processor in a second node according to one embodiment of the present application, as shown in FIG. 14. In FIG. 14, a processor 1300 of a second node comprises a second transmitter 1301 and a second receiver 1302.

In one embodiment, the second node is a base station.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in Embodiment 4.

In one embodiment, the second receiver 1302 comprises at least one of the antenna 420, the receiver 418, the receiving processor 470, the multi-antenna receiving processor 472, the controller/processor 475, the memory 476 in Embodiment 4.

The second transmitter 1301 transmits a first signaling;
the second receiver 1302 receives a first signal;

In embodiment 14, a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

In one embodiment, the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

In one embodiment, when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set.

In one embodiment, when and only when the first condition is not satisfied, the first signaling is used to indicate the target value from the first candidate value set.

In one embodiment, the first signaling comprises a first field, and the first field in the first signaling is used to indicate the first reference signal resource from the first reference signal resource set or the second reference signal resource set; an interpretation of the first field in the first signaling is related to whether the first condition is satisfied.

In one embodiment, a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

In one embodiment, the second receiver 1302 receives a first information block; herein, the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IoT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any changes and modifications made based on the embodiments described in the specification, if similar partial or complete technical effects can be achieved, shall be deemed obvious and fall within the scope of protection of the present invention.

What is claimed is:

1. A first node for wireless communications, comprising:
a first receiver, receiving a first signaling; and
a first transmitter, transmitting a first signal;
wherein a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

2. The first node according to claim 1, wherein the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

3. The first node according to claim 1, wherein
when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set;
or,
when and only when the first condition is not satisfied, the first signaling is used to indicate the target value from the first candidate value set.

4. The first node according to claim 1, wherein the first signaling comprises a first field, and the first field in the first signaling is used to indicate the first reference signal resource from the first reference signal resource set or the second reference signal resource set; an interpretation of the first field in the first signaling is related to whether the first condition is satisfied;
or,
the first signaling comprises a first field, and the first field in the first signaling is used to indicate the first reference signal resource from the first reference signal resource set or the second reference signal resource set; a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

5. The first node according to claim 1, wherein the second transmitter transmits a first information block; wherein the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

6. A second node for wireless communications, comprising:
a second transmitter, transmitting a first signaling; and
a second receiver, receiving a first signal;
wherein a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

7. The second node according to claim 6, wherein the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

8. The second node according to claim 6, wherein
when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set;
or,
when and only when the first condition is not satisfied, the first signaling is used to indicate the target value from the first candidate value set.

9. The second node according to claim 6, wherein
the first signaling comprises a first field, and the first field in the first signaling is used to indicate the first reference signal resource from the first reference signal resource set or the second reference signal resource set; an interpretation of the first field in the first signaling is related to whether the first condition is satisfied;
or,
the first signaling comprises a first field, and the first field in the first signaling is used to indicate the first reference signal resource from the first reference signal resource set or the second reference signal resource set; a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

10. The second node according to claim 6, wherein the second receiver receives a first information block; wherein the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

11. A method in a first node for wireless communications, comprising:
receiving a first signaling; and
transmitting a first signal;
wherein a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

12. The method according to claim 11, wherein the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

13. The method according to claim 11, comprising:
when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set;
or,
when and only when the first condition is not satisfied, the first signaling is used to indicate the target value from the first candidate value set.

14. The method according to claim 11, comprising:
the first signaling comprises a first field, and the first field in the first signaling is used to indicate the first reference signal resource from the first reference signal resource set or the second reference signal resource set; an interpretation of the first field in the first signaling is related to whether the first condition is satisfied;
or,
the first signaling comprises a first field, and the first field in the first signaling is used to indicate the first reference signal resource from the first reference signal resource set or the second reference signal resource set; a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

15. The method according to claim 11, comprising:
transmitting a first information block;
wherein the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.

16. A method in a second node for wireless communications, comprising:
transmitting a first signaling; and
receiving a first signal;
wherein a reference signal resource in a first reference signal resource set is used to determine an antenna port group for transmitting a first-type signal, and a reference signal resource in a second reference signal resource set is used to determine an antenna port group for transmitting a second-type signal; the first signal is the first-type signal or the second-type signal, the first signaling is used to indicate a first reference signal resource from the first reference signal resource set or the second reference signal resource set, and the first reference signal resource is used to determine an antenna port group for transmitting the first signal; a target parameter is used to determine transmit power of the first-type signal and transmit power of the second-type signal; a first candidate value group comprises one or multiple candidate values of the target parameter corresponding to the first reference signal resource; the first candidate value group comprises a target value, the target value is a candidate value of the target parameter corresponding to the first reference signal resource, and the target value is used to determine transmit power of the first signal; a number of candidate value(s) comprised in the first candidate value group is related to whether a first condition is satisfied; a first integer is a number of candidate value(s) comprised in the first candidate value group when the first condition is satisfied, and a second integer is a number of candidate value(s) comprised in the first candidate value group when the first condition is not satisfied, the first integer being a positive integer, the second integer being a positive integer greater than the first integer; the first condition comprises that the first-type signal and the second-type signal are not overlapping in time domain.

17. The method according to claim 16, wherein the first integer is equal to 1, and the second integer is greater than 1; when the first condition is satisfied, the first reference signal resource corresponds to only one candidate value of the target parameter, the target value is the only one candidate value of the target parameter corresponding to the first reference signal resource, and the first candidate value group only comprises the target value; when the first condition is not satisfied, the first reference signal resource corresponds to multiple candidate values of the target parameter, the first candidate value group comprises the multiple candidate values of the target parameter corresponding to the first reference signal resource, and the target value is a candidate value in the first candidate value group.

18. The method according to claim 16, comprising:
when the first condition is not satisfied, the target value being which candidate value in the first candidate value group is related to whether a second condition is satisfied; the second condition comprises that the first signaling also indicates a second reference signal resource; the first reference signal resource belongs to the first reference signal resource set and the second reference signal resource belongs to the second reference signal resource set, or, the first reference signal resource belongs to the second reference signal resource set and the second reference signal resource belongs to the first reference signal resource set;
or,
when and only when the first condition is not satisfied, the first signaling is used to indicate the target value from the first candidate value set.

19. The method according to claim 16, comprising:
the first signaling comprises a first field, and the first field in the first signaling is used to indicate the first reference signal resource from the first reference signal resource set or the second reference signal resource set; an interpretation of the first field in the first signaling is related to whether the first condition is satisfied;
or,
the first signaling comprises a first field, and the first field in the first signaling is used to indicate the first reference signal resource from the first reference signal resource set or the second reference signal resource set; a size of the first field in the first signaling is related to whether the first condition is satisfied, and the size of the first field is a number of bit(s) comprised in the first field; when the first condition is satisfied, a third integer is used to determine the size of the first field in the first signaling; when the first condition is not satisfied, a fourth integer is used to determine the size of the first field in the first signaling; the third integer is related to a number of reference signal resources comprised in the first reference signal resource set or a number of reference signal resources comprised in the second reference signal resource set, and the fourth integer is greater than the third integer.

20. The method according to claim 16, comprising:
receiving a first information block;
wherein the first information block comprises a first power difference value, and the first power difference value is equal to a first power threshold minus the transmit power of the first signal; the first power threshold is related to the target parameter, or the first power threshold is related to whether the first condition is satisfied, or a number of power difference value(s) comprised in the first information block is related to whether the first condition is satisfied.
